(19) United States
(12) Patent Application Publication
(10) Pub. No.: US 2026/0170999 A1
(43) Pub. Date: Jun. 18, 2026

(54) DISPLAY PANEL AND DISPLAY APPARATUS

(71) Applicant: Tianma Advanced Display Technology Institute (Xiamen) Co., Ltd., Xiamen (CN)

(72) Inventors: Zhenyu JIA, Xiamen (CN); Kerul XI, Xiamen (CN); Tianyi WU, Xiamen (CN); Yingteng ZHAI, Xiamen (CN); Fanqing MENG, Xiamen (CN); Yifan XING, Xiamen (CN)

(73) Assignee: Tianma Advanced Display Technology Institute (Xiamen) Co., Ltd., Xiamen (CN)

(21) Appl. No.: 19/075,833

(22) Filed: Mar. 11, 2025

(30) Foreign Application Priority Data
Dec. 18, 2024 (CN) 202411874948.X

(51) Int. Cl. G09G 3/32

(52) U.S. Cl. CPC G09G 3/32; G09G 2300/0426; G09G 2310/0267; G09G 2320/0233; G09G 2320/0633; G09G 2320/064; G09G 2330/06

(57) ABSTRACT

The present application discloses a display panel and a display apparatus. The display panel includes a display area that includes a first area and a second area at least partially surrounding the first area, gate driving circuits and pixel circuits electrically connected to the gate driving circuits are provided in the first area, trigger traces are provided in the second area, no pixel circuits are provided in the second area, and the trigger traces are electrically connected to the gate driving circuits.

### CROSS-REFERENCE TO RELATED APPLICATION

The present application claims priority to Chinese patent application No. 202411874948.X, entitled “DISPLAY PANEL AND DISPLAY APPARATUS”, filed on Dec. 18, 2024, the entire contents of which are incorporated here by reference.

### TECHNICAL FIELD

The present application relates to the field of display technology, and particularly, to a display panel and a display apparatus.

### BACKGROUND

With the development of display technology, display panels are more and more widely applied, and users are having more and more demands on the display panels. The display panels are gradually developing towards lightness, thinness, high screen-to-body ratio, and even bezel-less-ness.

### SUMMARY

Embodiments of the present application provide a display panel and a display apparatus, which can achieve bezel-less-ness and improve the stability of the gate driving circuit.

In a first aspect, embodiments of the present application provide a display panel including a display area, and the display area includes a first area and a second area at least partially surrounding the first area, gate driving circuits and pixel circuits electrically connected to the gate driving circuits are provided in the first area, trigger traces are provided in the second area, no pixel circuits are provided in the second area, and the trigger traces are electrically connected to the gate driving circuits.

In a second aspect, embodiments of the present application provide a display apparatus including the display panel according to any one of the embodiments of the first aspect.

### BRIEF DESCRIPTION OF THE DRAWINGS

Other features, objects and advantages of the present application will become more apparent from reading the following detailed description of the non-limiting embodiments with reference to the drawings, in which the same or similar reference numerals represent the same or similar features, and the drawings are not drawn to actual scale.

FIG. 1 shows a schematic structural view of a display panel according to embodiments of the present application;

FIG. 2 shows another schematic structural view of a display panel according to embodiments of the present application;

FIG. 3 shows yet another schematic structural view of a display panel according to embodiments of the present application;

FIG. 4 shows yet another schematic structural view of a display panel according to embodiments of the present application;

FIG. 5 shows a schematic structural view of a layout of area Q1 in FIG. 4;

FIG. 6 shows a schematic view of a stack of film layers of a display panel according to embodiments of the present application;

FIG. 7 shows yet another schematic structural view of a display panel according to embodiments of the present application;

FIG. 8 shows yet another schematic structural view of a display panel according to embodiments of the present application;

FIG. 9 shows a schematic structural view of a pixel circuit in a display panel according to embodiments of the present application;

FIG. 10 shows another schematic structural view of a pixel circuit of a display panel according to embodiments of the present application;

FIG. 11 shows yet another schematic structural view of a pixel circuit of a display panel according to embodiments of the present application;

FIG. 12 shows yet another schematic structural view of a display panel according to embodiments of the present application;

FIG. 13 shows yet another schematic structural view of a display panel according to embodiments of the present application;

FIG. 14 shows yet another schematic structural view of a display panel according to embodiments of the present application;

FIG. 15 shows yet another schematic structural view of a display panel according to embodiments of the present application;

FIG. 16 shows an enlarged schematic view of area Q2 of FIG. 13;

FIG. 17 shows yet another schematic structural view of a display panel according to embodiments of the present application;

FIG. 18 shows a schematic structural view of a static electricity protection circuit in a display panel according to embodiments of the present application;

FIG. 19 shows yet another schematic structural view of a display panel according to embodiments of the present application; and

FIG. 20 shows a schematic structural view of a display apparatus according to embodiments of the present application.

### DETAILED DESCRIPTION

Features and exemplary embodiments of various aspects of the present application will be described in detail below, and in order to make the purpose, technical solutions and advantages of the present application clearer, the present application is described in further detail below in combination with the drawings and specific embodiments. It should be understood that the specific embodiments described herein are only used to explain the present application, but not to limit the present application. For those skilled in the art, the present application can be implemented without some of these specific details. The following description of the embodiments is only to provide a better understanding of the present application by illustrating examples of the present application.

It should be noted that, in the present application, the relational terms, such as first and second, are used merely to distinguish one entity or operation from another entity or operation, without necessarily requiring or implying any actual such relationships or orders for these entities or operations. Moreover, the terms “comprise”, “include”, or any other variants thereof, are intended to represent a non-exclusive inclusion, such that a process, method, article or device including a series of elements includes not only those elements, but also other elements that are not explicitly listed or elements inherent to such a process, method, article or device. Without more constraints, the elements following an expression “comprise/include . . . ” do not exclude the existence of additional identical elements in the process, method, article or device that includes the elements.

It should be understood that when the structure of a component is described, if a layer/area is referred to as being “on” or “above” another layer/region, it may mean that the layer/area is directly on the other layer/region or that other layers/regions may be included between the layer/area and the other layer/area. Moreover, if the component is turned over, the layer/area will be “below” or “under” the other layer/area.

It should be understood the term “and/or” used herein refers to only an association relationship for describing associated objects, and means that there may be three kinds of relationships. For example, “A and/or B” may represent three cases including: “A exists alone”, “A and B exist simultaneously”, and “B exists alone”. In addition, the character “/” herein generally indicates that the associated objects have an “or” relationship.

In the embodiments of the present application, the term “electrically connected” may indicate that two components are directly electrically connected, or that the two components are electrically connected via one or more other components.

The term “connected” may mean “electrically connected” or “electrically connected not by an intermediate transistor”. The term “insulated” may mean “electrically insulated” or “electrically isolated”. The term “drive” may mean “control” or “operate”. The term “part” may mean “portion”. The term “pattern” may mean “member”. The term “end” may mean “a segment of the end” or “an edge of the end”. The display panel may be a display apparatus or a module/part of a display apparatus.

It will be apparent to those skilled in the art that various modifications and variations can be made to the present application without departing from the gist or scope of the present application. Accordingly, the present application is intended to encompass the modifications and variations to the present application that fall within the scope of the appended claims (the claimed technical solutions) and equivalents thereof. It should be noted that implementations provided by the embodiments of the present application can be combined with one another if there is no conflict.

Before the technical solutions provided by the embodiments of the present application are described, the problems in the art are first described in the present application to facilitate the understanding of the embodiments of the present application.

The display panel includes a pixel circuit, a light-emitting device, and a gate driving circuit. The gate driving circuit is provided with a trigger signal through a trigger trace. The gate driving circuit is connected to the pixel circuit by a gate trace, and a gate control signal output by the gate driving circuit is transmitted to the pixel circuit through the gate trace, so as to control the pixel circuit to generate a driving current, thereby driving the light-emitting device to emit light.

The pixel circuit and the light-emitting device are located in a display area of the display panel. In the related art, the pixel circuits in the peripheral display area are shrunk to provide the space for the gate driving circuits, and such design may achieve bezel-less-ness under a condition that the architecture of the gate driving circuits required for the pixel circuits is not complicated (that is, the number of the gate driving circuits is not large). However, as the requirement for the driving performance is increased, the number of the gate driving circuits will be increased, so that the design which only relies on the shrinkage of the pixel circuits in the peripheral display area to provide the space for placing the gate driving circuits can not meet the requirements for the structural design of a plurality of groups of gate driving circuits. In addition, the gate driving circuit is provided with the trigger signal through the trigger trace, and the stability of the trigger signal affects the reliability of the gate driving circuit, therefore, how to achieve bezel-less-ness and ensure the reliability of the gate driving circuit is a technical problem faced by a person skilled in the art.

In order to solve the above technical problem, embodiments of the present application provide a display panel and a display apparatus, which will be described below with reference to the drawings.

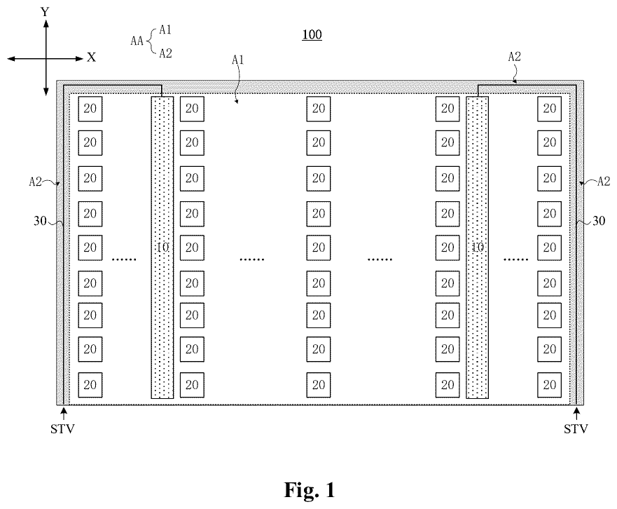

As shown in FIG. 1, the display panel 100 according to embodiments of the present application includes the display area AA, and it may be understood that the display area AA includes the pixel circuits 20 and light-emitting devices (not shown in FIG. 1), and the display area AA is used for displaying images.

In an example, the display panel in the embodiments of the present application is a narrow bezel display panel or even a bezel-less display panel, that is, along the first direction X, the non-display areas on the left side and the right side of the display area AA are very small, or the non-display areas may even not be provided on the left side and the right side of the display area AA. In the drawings of the present application, the bezel-less display panel is given as an example.

The display area AA includes the first area A1 and the second area A2 that at least partially surrounds the first area A1. In order to distinguish, in the drawings of the present application, the first area A1 is represented by a white-filled area, and the second area A2 is represented by a light-gray-filled area. At least part of the peripheral area of the display area AA is the second area A2. In an example, along the first direction X, the second area A2 is provided on at least one side of the first area A1; and along the second direction Y, the second area A2 is provided on at least one side of the first area A1. In the example shown in FIG. 1, the second area A2 is provided on two sides of the first area A1 along the first direction X, the second area A2 is provided on one side of the first area A1 that is along the second direction Y and away from a driving chip (that is, the upper side of the first area A1 in FIG. 1), and the second area A2 is not provided on one side of the first area A1 that is along the second direction Y and close to the driving chip (that is, the lower side of the first area A1 in FIG. 1), which is not intended to limit the present application.

It may be understood that the light-emitting devices are provided in the first area A1 and the second area A2, and the first area A1 and the second area A2 can display images.

The gate driving circuits 10 and the pixel circuits 20 are provided in the first area A1, and the gate driving circuits 10 are electrically connected to the pixel circuits 20. The trigger traces 30 are provided in the second area A2, and no pixel circuits are provided in the second area A2. The trigger traces 30 are electrically connected to the gate driving circuits 10.

In an example, the other end of the trigger trace 30 is electrically connected to the driving chip (not shown in the drawing), and the trigger signal STV provided by the driving chip is transmitted to the gate driving circuit 10 through the trigger trace 30, thereby triggering the gate driving circuit 10 to operate.

In an example, a plurality of pixel circuits 20 are arranged in an array along the first direction X and the second direction Y. Herein, the first direction X intersects with the second direction Y. For example, the first direction X is the row direction, and the second direction Y is the column direction.

In an example, along the first direction X, the gate driving circuit 10 is spaced apart from the trigger trace 30 by at least one column of pixel circuits 20. In this example, the gate driving circuits are no longer limited at the outermost edge of the display area along the first direction, but are provided close to the center of the display area along the first direction, so that the distance from the gate driving circuits to the center of the display area can be shortened, and the distance for the gate driving circuits to charge the pixel circuits in the center of the display area can be shortened, thereby reducing the signal delay and the voltage drop, and improving the display uniformity.

No pixel circuits are provided in the second area A2, and it may be understood that the trigger traces 30 do not overlap the pixel circuits 20 along the thickness direction of the display panel.

In an example, the gate driving circuits 10 are electrically connected to the pixel circuits 20 by gate traces (not shown) that extend along the first direction X. Generally, the gate traces may be provided in the area where the pixel circuits 20 are located, that is, the gate traces are provided in the first area A1, and it may be understood that the trigger traces 30 may not overlap the gate traces along the thickness direction of the display panel. As such, the interference of the signals on the gate traces in the signals on the trigger traces is reduced.

In an example, the pixel circuits 20 are further connected to data lines (not shown). Generally, the data lines may be provided in the area where the pixel circuits 20 are located and extend along the second direction Y. That is, the data lines are also provided in the first area A1, and it may be understood that the trigger traces 30 may not overlap the data lines along the thickness direction of the display panel. As such, the interference of the signals on the data lines in the signals on the trigger traces is reduced.

The pixel circuit 20 may further be connected to other signal lines such as a reset signal line, a power supply signal line to name but a few.

In the display panel according to the embodiments of the present application, the gate driving circuits and the trigger traces are located in the display area, which can achieve a narrow bezel or even bezel-less-ness; in addition, the trigger traces are located in the second area around the periphery, and no pixel circuits are provided in the second area, so that the trigger traces, the pixel circuits, and the signal lines connected to the pixel circuits may not overlap each other, which can reduce the interference of other signals in the signals on the trigger traces, thereby improving the stability of the gate driving circuits.

With the development of display technology, requirements for the driving performance of the display panel become higher and higher. In view of this, the display panel may include a plurality of gate driving circuits to improve the driving performance of the gate driving circuits. Under a condition that the display panel includes the plurality of gate driving circuits, the display panel may include a plurality of trigger traces.

In some embodiments, the 1st one to the n-th one of the trigger traces are electrically connected to the 1st one to the n-th one of the gate driving circuits in a one-to-one correspondence, and n≥2; and the 1st one to the n-th one of the trigger traces do not intersect with each other.

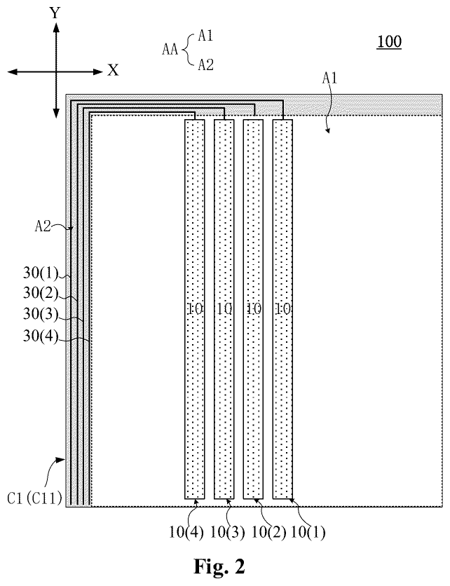

As an example, as shown in FIG. 2, the display panel includes four gate driving circuits and four trigger traces, the 1st gate driving circuit 10 (1) is electrically connected to the 1st trigger trace 30 (1), the 2nd gate driving circuit 10 (2) is electrically connected to the 2nd trigger trace 30 (2), the 3rd gate driving circuit 10 (3) is electrically connected to the 3rd trigger trace 30 (3), the 4th gate driving circuit 10 (4) is electrically connected to the 4th trigger trace 30 (4), and the 1st trigger trace to the 4th trigger trace do not intersect with each other.

It should be noted that the arrangement of the plurality of trigger traces in the drawings of the present application is only one of the embodiments, and other trace arrangements in which the plurality of trigger traces do not intersect with each other are also feasible.

In this embodiment, by designing that the plurality of trigger traces do not intersect with each other, a parasitic capacitance formed by intersecting of the trigger traces may be avoided, and the signal interference among the trigger traces may be reduced, so that the stability of signals on trigger traces is ensured, thereby ensuring the stability of gate driving circuits.

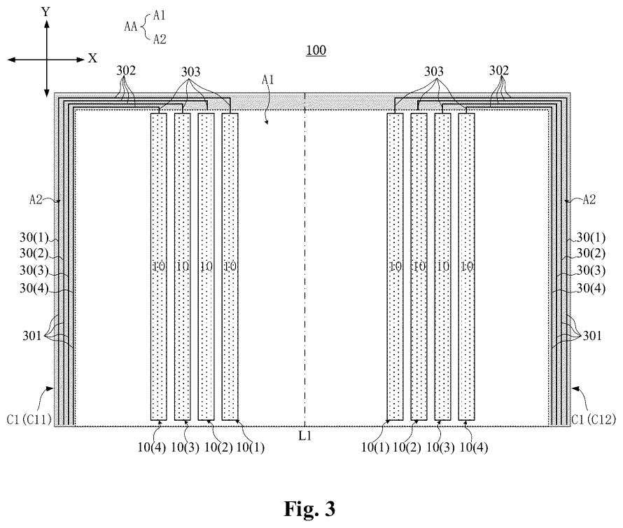

In some embodiments, as shown in FIG. 3, the trigger traces each include the first segment 301, the second segment 302, and the third segment 303 which are connected to one another, the second segment 302 is electrically connected between the first segment 301 and the third segment 303, the first segment 301 is electrically connected to a trigger signal terminal (not shown in the drawing) of the driving chip, the third segment 303 is electrically connected to the gate driving circuit 10, the first segment 301 and the third segment 303 extend along the second direction Y, and the second segment 302 extends along the first direction X.

In an example, the display panel includes the first middle line L1 that extends along the second direction Y, and along the first direction X, distances from the first middle line L1 to two edges of the display panel are the same. For example, the distance from the first middle line L1 to the edge C11 is equal to the distance from the first middle line L1 to the edge C12.

It should be noted that the first middle line L1 is located in the display area and parallel or substantially parallel to the first edges C1. The first middle line does not represent a trace that actually exists in the display panel, and may be understood to be a virtual line that defines the position of the display panel, that is, the first middle line represents a position. As limited herein, expressions such as “equal”, “equal to”, and “=” used for representing the relationships among two or more parameters may not mean the parameters are absolutely equal, allowing for certain error. It should be noted that the “distances being equal” mentioned in the present disclosure means that values of the distances are equal within the error range (±5%).

For the display area on either side of the first middle line L1 along the first direction X, along the first direction X, the arrangement order of the first segments 301 of the 1st one to the n-th one of the trigger traces is opposite to the arrangement order of the 1st one to the n-th one of the gate driving circuits; and the arrangement order of the third segments 303 of the 1st one to the n-th one of the trigger traces is the same as the arrangement order of the 1st one to the n-th one of the gate driving circuits. In addition, along the second direction Y, the second segments of the 1st one to the n-th one of the trigger traces may be arranged closer to the gate driving circuits in sequence.

For example, for the display area located at the left side of the first middle line L1 in FIG. 3 (that is, the left half screen in FIG. 3), the 1st gate driving circuit 10 (1) to the 4th gate driving circuit 10 (4) are electrically connected to the 1st trigger trace 30 (1) to the 4th trigger trace 30 (4) in a one-to-one correspondence, the 1st gate driving circuit 10 (1) to the 4th gate driving circuit 10 (4) are arranged away from the first middle line L1 in sequence, the first segments 301 of the 1st trigger trace 30 (1) to the 4th trigger trace 30 (4) are arranged closer to the first middle line L1 in sequence, and the third segments 303 of the 1st trigger trace 30 (1) to the 4th trigger trace 30 (4) are arranged away from the first middle line L1 in sequence. In addition, along the second direction Y, the second segments 302 of the 1st trigger trace 30 (1) to the 4th trigger trace 30 (4) are arranged closer to the gate driving circuits in sequence.

In this embodiment, the arrangement order of the plurality of gate driving circuits and the plurality of trigger traces may make the plurality of trigger traces not intersect with each other, thereby reducing the mutual interference among the trigger traces.

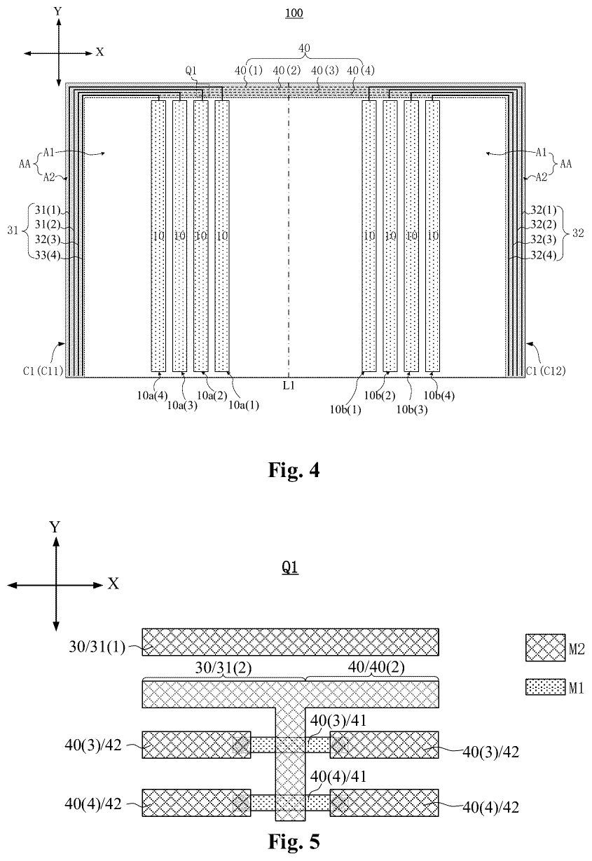

In some embodiments, as shown in FIG. 4, the trigger traces 30 include the first trigger traces 31 and the second trigger traces 32, and along the first direction X, the first trigger traces 31 and the second trigger traces 32 are located at two sides of the center of the display area, respectively. The trigger connection lines 40 are provided in the second area A2 and are electrically connected between the first trigger traces 31 and the second trigger traces 32.

It should be noted that, in order to distinguish the trigger traces from the trigger connection lines, in the drawings herein, the trigger traces 30 are shown in solid lines, the trigger connection lines 40 are shown in dashed lines, and the traces shown in the dashed lines are not intended to indicate that the traces are disconnected.

In an example, in FIG. 4, the first trigger traces 31 are located at the left side of the first middle line L1, the second trigger traces 32 are located at the right side of the first middle line L1, and the first middle line L1 is the center line of the display area. In FIG. 4, an example is given in which four first trigger traces 31 and four second trigger traces 32 are provided at two sides of the first middle line L1, respectively, and the four first trigger traces 31 may be electrically connected to the four second trigger traces 32 in a one-to-one correspondence by four trigger connection lines 40. For example, the 1st trigger connection line 40 (1) is connected between the 1st first trigger trace 31 (1) and the 1st second trigger trace 32 (1), the 2nd trigger connection line 40 (2) is connected between the 2nd first trigger trace 31 (2) and the 2nd second trigger trace 32 (2), the 3rd trigger connection line 40 (3) is connected between the 3rd first trigger trace 31 (3) and the 3rd second trigger trace 32 (3), and the 4th trigger connection line 40 (4) is connected between the 4th first trigger trace 31 (4) and the 4th second trigger trace 32 (4).

In this embodiment, by providing the trigger connection line, the first trigger line and the second trigger line which are at two sides along the first direction may be connected, so that under a condition that one of the first trigger line and the second trigger line is disconnected, the trigger signal may be transmitted to the gate driving circuit through the other of the first trigger line and the second trigger line, and under a condition that both the first trigger line and the second trigger line are connected, the trigger signal may be transmitted from two sides to the gate driving circuit, which is beneficial for improving the display uniformity.

It may be understood that the trigger signals on the first trigger traces and the second trigger traces which are electrically connected to each other are the same, and the signals output by the plurality of gate driving circuits electrically connected to the first trigger trace and the second trigger trace which are electrically connected to each other are the same. For example, the i-th first trigger trace 31 (i) is electrically connected to the gate driving circuit 10a (i), the i-th second trigger trace 32 (i) is electrically connected to the gate driving circuit 10b (i), the i-th first trigger trace 31 (i) is electrically connected to the i-th second trigger trace 32 (i), the signals output by the gate driving circuit 10a (i) and the gate driving circuit 10b (i) are the same, and i is any one of 1 to n. For example, taking FIG. 4 as an example, i is any one of 1 to 4, the signals output by the gate driving circuit 10a (1) and the gate driving circuit 10b (1) are the same, the signals output by the gate driving circuit 10a (2) and the gate driving circuit 10b (2) are the same, the signals output by the gate driving circuit 10a (3) and the gate driving circuit 10b (3) are the same, and the signals output by the gate driving circuit 10a (4) and the gate driving circuit 10b (4) are the same.

In some embodiments, as shown in FIG. 5, at least one of the trigger connection lines 40 includes the first connection segment 41 and the second connection segment 42 which are connected to each other, the first connection segment 41 at least partially overlaps the trigger traces 30, and the second connection segment 42 does not overlap the trigger traces 30. The line width of the first connection segment 41 is less than the line width of the second connection segment 42. In this embodiment, by designing the line width of the first connection segment 41 to be relatively small, an excessively large overlapped area between the first connection segment 41 and the trigger trace 30 may be avoided, thereby reducing the interference between the first connection segment 41 and the trigger trace 30 that transmit different signals.

For example, the trigger connection lines 40 extend along the first direction X, and a plurality of trigger connection lines 40 are arranged along the second direction Y. The 1st trigger connection line 40 (1) is located at the outermost side and may not have to be segmented. The 2nd trigger connection line 40 (2) to the 4th trigger trace 40 (4) may each include the first connection segment 41 and the second connection segment 42 which are electrically connected to each other. For at least one of the trigger connection lines 40, both ends of the first connection segment 41 are electrically connected to the second connection segment 42, and at least one of the second connection segments 42 is connected to the trigger trace 30.

In an example, the length of the trigger connection line 40 that needs to intersect the trigger trace 30 extending along the second direction Y is relatively small, and for one of the trigger connection lines 40, the total length of the first connection segment 41 of the trigger connection line 40 is less than the total length of the second connection segment 42 of the trigger connection line 40, so that the relatively thick second connection segment 42 occupies a large proportion of the trigger connection line 40, thereby avoiding an excessive increase in the total impedance of the trigger connection line 40.

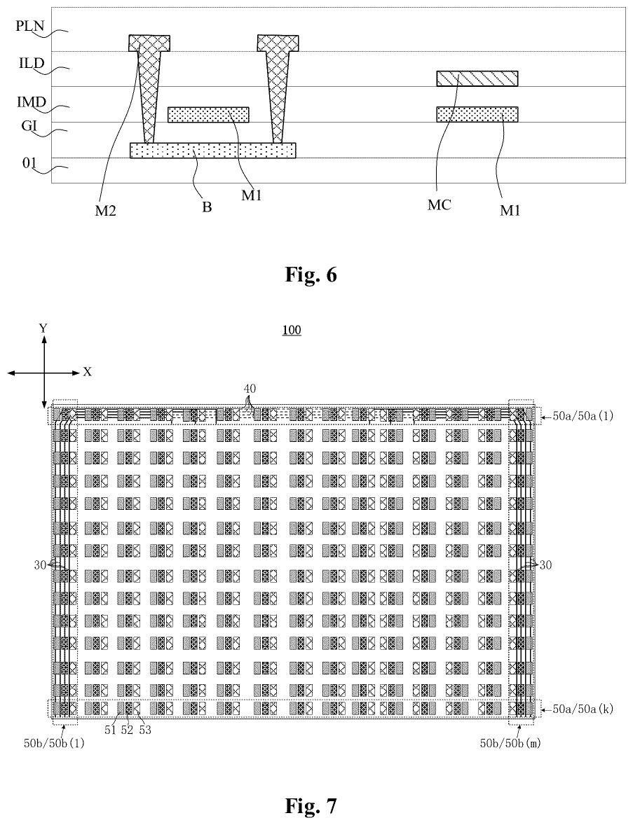

In some embodiments, as shown in FIG. 5 and FIG. 6, the display panel includes the first metal layer M1 and the second metal layer M2 which are separated by the insulation layer. Materials of the first metal layer M1 and the second metal layer M2 may be different. The sheet resistance of the second metal layer M2 is less than the sheet resistance of the first metal layer M1.

In an example, the first connection segment 41 is located in the first metal layer M1 of the display panel, and the second connection segment 42 is located in the second metal layer M2 of the display panel. The first connection segment 41 is connected to the second connection segment 42 by a via.

For one trigger connection line 40, the total length of the second connection segment 42 of the trigger connection line 40 is greater than the total length of the first connection segment 41 of the trigger connection line 40. In this embodiment, the second connection segment 42 is provided in the second metal layer M2 with the relatively low sheet resistance, so that the impedance of the second connection segment 42 is lower, and the total impedance of the trigger connection line 40 is relatively low, and thus the signal delay due to relatively high impedance may be reduced.

In some embodiments, the first trigger traces 31 and the second trigger traces 32 may be located in the second metal layer M2. As such, when the first trigger trace 31 and the second trigger trace 32 are connected to the trigger connection line 40, a connection via may not have to be provided, and the first trigger trace 31, the second trigger trace 32, and the second connection segment 42 of the trigger connection line 40 may be integrally formed.

In an example, a non-segmented trigger connection line (such as the trigger connection line 40 (1) in FIG. 4) may be located in the second metal layer M2.

In some embodiments, as shown in FIG. 6, the display panel includes the substrate 01, the first metal layer M1 is located between the second metal layer M2 and the substrate 01, and the gates of the transistors in the gate driving circuits are located in the first metal layer.

In an example, the display panel further includes the semiconductor layer B and the capacitive metal layer MC, the semiconductor layer B is located between the first metal layer M1 and the substrate 01, and the capacitive metal layer MC is located between the first metal layer M1 and the second metal layer M2. The active layer of the transistor in the gate driving circuit is provided in the semiconductor layer B. As an example, the material of the semiconductor layer B includes polysilicon (poly).

As described in the above embodiments, the light-emitting devices are provided in the area where the trigger traces are located.

In some embodiments, as shown in FIG. 7, the display area of the display panel includes a plurality of light-emitting-device columns 50b and a plurality of light-emitting-device rows 50a. The plurality of light-emitting-device rows 50a are arranged along the second direction Y, and each of the light-emitting-device rows 50a includes a plurality of light-emitting devices which are arranged along the first direction X. The plurality of light-emitting-device columns 50b are arranged along the first direction X, and each of the light-emitting-device columns 50b includes a plurality of light-emitting devices which are arranged along the second direction Y. For illustration, FIG. 7 shows that each of the light-emitting devices includes the first light-emitting device 51, the second light-emitting device 52, and the third light-emitting device 53, and colors of light emitted by the first light-emitting device 51, the second light-emitting device 52, and the third light-emitting device 53 may be different from each other. In an example, the first light-emitting device 51, the second light-emitting device 52, and the third light-emitting device 53 form a light-emitting unit used for displaying white light. One light-emitting-device column 50b may include at least one column of first light-emitting devices 51, at least one column of second light-emitting devices 52, and at least one column of third light-emitting devices 53.

Along the thickness direction of the display panel, the trigger traces 30 overlap the 1st light-emitting-device column 50b (1) or the last light-emitting-device column 50b (m).

For example, the 1st light-emitting-device column 50b (1) is located at the first side of the display panel, and the last light-emitting-device column 50b (m) is located at the second side of the display panel. In an example, under a condition that the trigger traces are provided at two sides along the first direction X, the 1st light-emitting-device column 50b (1) overlaps the trigger traces 30 which are at the first side of the display panel, and the last light-emitting-device column 50b (m) overlaps the trigger traces 30 which are at the second side of the display panel.

In this embodiment, the trigger traces are designed to overlap the 1st one of the light-emitting-device columns or the last one of the light-emitting-device columns, which may ensure that the trigger traces are located around the periphery of the display panel along the first direction, thereby reducing the interference of other signal lines in the trigger traces.

In some embodiments, as shown in FIG. 7, along the thickness direction of the display panel, the trigger traces 30 at least partially overlap the 1st light-emitting-device row 50a (1).

Along the second direction Y, the 1st light-emitting-device row 50a (1) is located at the third side of the display panel, the last light-emitting-device row 50a (k) is located at the fourth side of the display panel, the third side of the display panel may be the side away from the driving chip, and the fourth side of the display panel may be the side close to the driving chip. In this embodiment, the trigger traces are designed to at least partially overlap the 1st one of the light-emitting-device rows, which may ensure that the trigger traces are located around the periphery of the display panel along the second direction, thereby reducing the interference of other signal lines in the trigger traces.

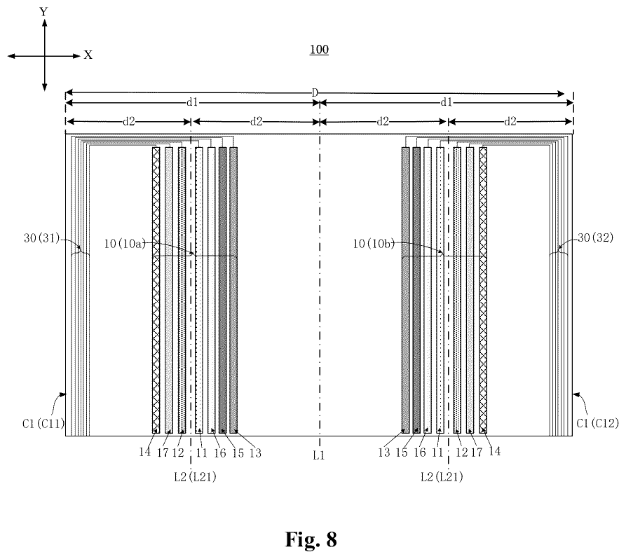

In some embodiments, as shown in FIG. 8, the display area of the display panel includes the first middle line L1, the width of the display panel along the first direction X is D, the first middle line L1 extends along the second direction Y, the distance between the first middle line L1 and each of the first edges C1 of the display panel along the first direction X is d1, d1=D/2, and at least one of the gate driving circuits 10 is provided at each of two sides of the first middle line L1 along the first direction X. The first edges C1 are the edges of the display panel extending along the second direction Y, each of the two sides of the display panel along the first direction X includes one first edge C1, one of the first edges C1 is the left first edge C11, the other of the first edges C1 is the right first edge C12, and the distance from the first middle line L1 to the left first edge C11 and the distance from the first middle line L1 to the right first edge C12 are both d1.

The trigger traces 30 and the gate driving circuits 10 which are at the first side of the first middle line L1 are the first trigger traces 31 and the first group of gate driving circuits 10a, respectively, and the first trigger traces 31 are electrically connected to the first group of gate driving circuits 10a. The trigger traces 30 and the gate driving circuits 10 which are at the second side of the first middle line L1 are the second trigger traces 32 and the second group of gate driving circuits 10b, respectively, and the second trigger traces 32 are electrically connected to the second group of gate driving circuits 10b.

In this embodiment, the display panel is divided into two half screens along the first direction, and the gate driving circuits are provided in each of the half screens, which breaks the conventional design thinking; as a result, the gate driving circuits are no longer limited in the peripheral display area but are dispersed at two sides of the first middle line, so that even if the number of the gate driving circuits is relatively great, there is a sufficient display area to accommodate the gate driving circuits, thereby achieving the narrow bezel or even the bezel-less-ness; in addition, compared to limiting the gate driving circuits in the peripheral display area, dispersing the gate driving circuits at two sides of the first middle line can shorten the distance from at least a part of the gate driving circuits to the center of the display area, and can shorten the distance for the gate driving circuits to charge the pixel circuits in the center of the display area, thereby reducing the signal delay and the voltage drop, and improving the display uniformity.

In some embodiments, n of the gate driving circuits 10 are provided at each of two sides of the first middle line L1 along the first direction X, and the gate driving circuits 10 at two sides of the first middle line L1 are symmetrically provided.

As an example, seven gate driving circuits are provided at each of two sides of the first middle line L1 along the first direction X, and each side includes the first gate driving circuit 11, the second gate driving circuit 12, the third gate driving circuit 13, the fourth gate driving circuit 14, the fifth gate driving circuit 15, the sixth gate driving circuit 16, and the seventh gate driving circuit 17, respectively; the signals output by two first gate driving circuits 11 are the same, the signals output by two second gate driving circuits 12 are the same, and the signals output by two third gate driving circuits 13 are the same; the signals output by two fourth gate driving circuits 14 are the same, the signals output by two fifth gate driving circuits 15 are the same, the signals output by two sixth gate driving circuits 16 are the same, and the signals output by two seventh gate driving circuits 17 are the same.

The two first gate driving circuits 11 are symmetric with respect to the first middle line L1, the two second gate driving circuits 12 are symmetric with respect to the first middle line L1, the two third gate driving circuits 13 are symmetric with respect to the first middle line L1, the two fourth gate driving circuits 14 are symmetric with respect to the first middle line L1, the two fifth gate driving circuits 15 are symmetric with respect to the first middle line L1, the two sixth gate driving circuits 16 are symmetric with respect to the first middle line L1, and the two seventh gate driving circuits 17 are symmetric with respect to the first middle line L1.

In an example, in order to meet driving requirements for a high-resolution display panel such as a micro light emitting diode (micro LED) or organic light emitting diode (OLED) display panel, the driving current intensity and the duration of the driving current are controlled by a pixel circuit using a combination of pulse amplitude modulation (PAM) and pulse width modulation (PWM) to control light emitting states of the light-emitting devices.

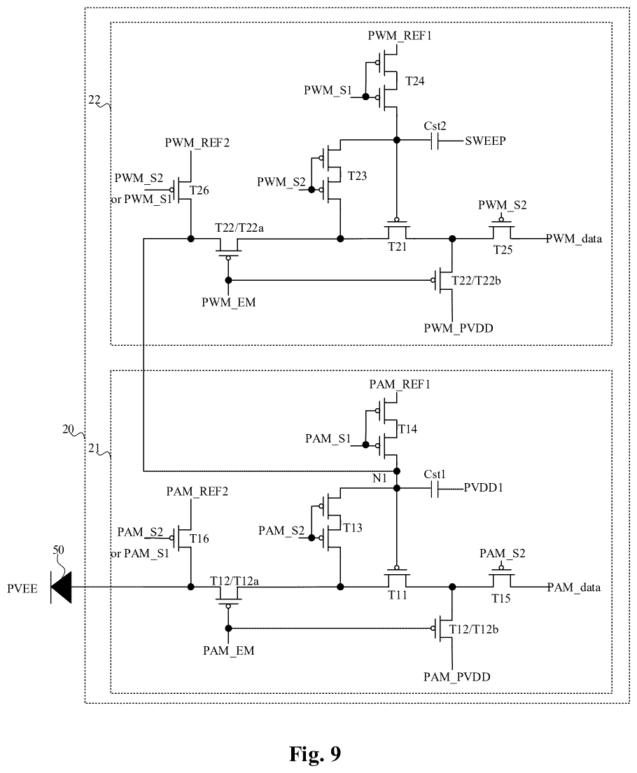

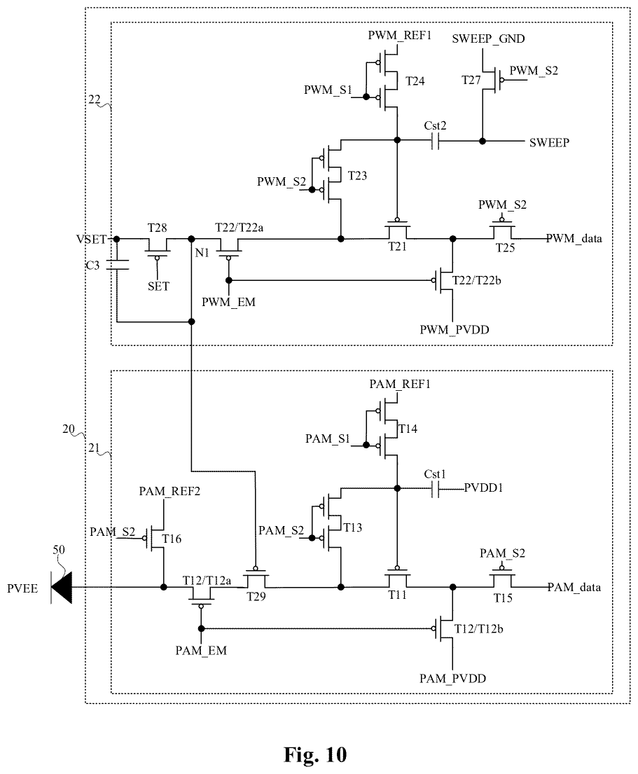

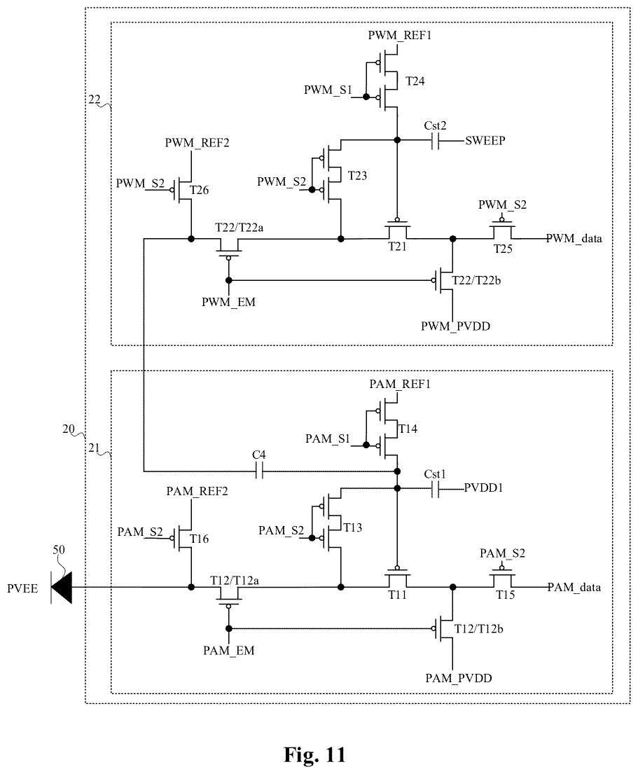

In some embodiments, as shown in any one of FIG. 9 to FIG. 11, the pixel circuits 20 of the display panel each include the amplitude modulation sub-circuit 21 and the pulse width modulation sub-circuit 22, and the pixel circuits 20 generate the driving current under the control of the amplitude modulation sub-circuits 21 and the pulse width modulation sub-circuits 22. The amplitude modulation sub-circuit 21 may be configured to control the amplitude of the driving current, and the pulse width modulation sub-circuit 22 may be configured to adjust the pulse width of the voltage applied to the first electrode of the light-emitting device 50.

The pulse width modulation sub-circuit 22 adjusts grayscale or brightness displayed by a light-emitting device by adjusting the pulse width of the voltage applied to the first electrode of the light-emitting device 50, that is, the pulse width modulation sub-circuit 22 adjusts the actual emission period during which the driving current is applied to the light-emitting device 50, while maintaining the driving current applied to the light-emitting device at a constant level, rather than adjusting the grayscale or brightness displayed by the light-emitting device only by adjusting the magnitude of the driving current applied to the light-emitting device. Therefore, the amplitude modulation sub-circuit 21 may provide the driving current for the light-emitting device, so that the light-emitting device is driven in the optimum light-emitting efficiency, and the grayscale or brightness displayed by the light-emitting device is adjusted by adjusting the light-emitting duty ratio of the light-emitting device (that is, the emission period of the light-emitting device) by the pulse width modulation sub-circuit 22.

It should be noted that the circuit structures shown in FIG. 9 to FIG. 11 are only examples and are not intended to limit the present application. Regardless of specific structures of the amplitude modulation sub-circuits and the pulse width modulation sub-circuits in the pixel circuits, data signals typically need to be written into the amplitude modulation sub-circuits and the pulse width modulation sub-circuits, so the design concept about the gate driving circuits in the present application may further be applied to pixel circuits in other structural forms than the circuit structures shown in FIG. 9 to FIG. 11.

In an example, the gate signal PAM_S2 output by the first gate driving circuits 11 is used for controlling the writing of the first data signal PAM_data into the amplitude modulation sub-circuits 21, the gate signal PWM_S2 output by the second gate driving circuits 12 is used for controlling the writing of the second data signal PWM_data into the pulse width modulation sub-circuits 22, the gate signal PAM_S1 output by the third gate driving circuits 13 is used for controlling the writing of the reset signal PAM_REF1 into the amplitude modulation sub-circuits 21, and the gate signal PWM_S1 output by the fourth gate driving circuits 14 is used for controlling the writing of the reset signal PWM_REF1 into the pulse width modulation sub-circuits 22. In addition, the fifth gate driving circuits 15 are configured to output the first light-emitting control signal PAM_EM, the sixth gate driving circuits 16 are configured to output the second light-emitting control signal PWM_EM, the seventh gate driving circuits 17 are configured to output the frequency sweep signal SWEEP, the fifth gate driving circuits 15 are electrically connected to the amplitude modulation sub-circuits 21, and the sixth gate driving circuits 16 and the seventh gate driving circuits 17 are electrically connected to the pulse width modulation sub-circuits 22.

In some embodiments, as shown in FIG. 8, the distance between each of the second middle lines L2 of the display area and the first middle line L1 of the display panel along the first direction X is d2, d2=D/4, and at least one of the gate driving circuits 10 is provided at each of two sides of the second middle line L2 along the first direction X.

In an example, the second middle lines L2 each include the 1st second middle line L21 and the 2nd second middle line L22 which are located at two sides of the first middle line L1, respectively; the distance between the 1st second middle line L21 and the edge C11 is d2, and the distance between the 2nd second middle line L22 and the edge C12 is d2; and the 1st second middle line L21, the 2nd second middle line L22, and the first middle line L1 divide the display area into four sub-areas, and the gate driving circuits are provided in each sub-area.

In an example, a plurality of gate driving circuits at the first side of the first middle line L1 are distributed close to the 1st second middle line L21, and a plurality of gate driving circuits at the second side of the first middle line L1 are distributed close to the 2nd second middle line L22. For example, the first gate driving circuit 11 and the second gate driving circuit 12 are provided directly adjacent to the second middle line L2, and in this example, for any one of the first gate driving circuits 11 or any one of the second gate driving circuits 12, the transmission distance of the output signal thereof is only about a quarter of the width D of the display panel, so that the transmission distance of the signal from the gate driving circuit to the pixel circuit can be shortened more effectively, thereby reducing the signal delay and the voltage drop, and improving the display uniformity.

The technical concept may further be explained by a positional relationship between a gate driving circuit and a pixel.

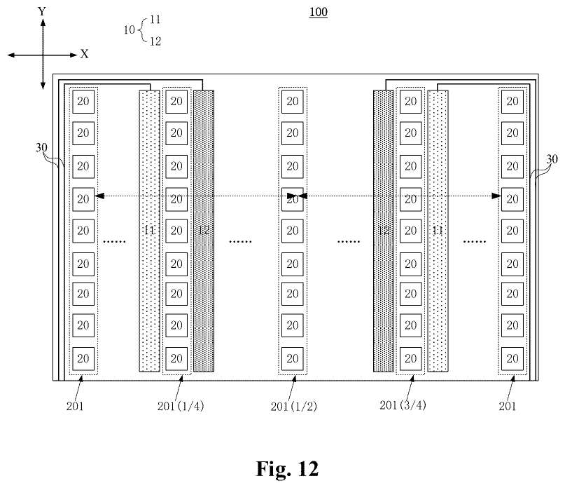

In some embodiments, as shown in FIG. 12, the display panel 100 includes N pixel-circuit columns 201 arranged along the first direction X, N is an integer, and the pixel-circuit columns 201 each include a plurality of pixel circuits 20 arranged along the first direction X. At least one of the gate driving circuits 10 is provided at each of two sides of the N/4-th pixel-circuit column 201 (1/4) along the first direction X, and N/4 takes the integer part.

In other words, the display panel includes N pixel columns arranged along the first direction, N is an integer, and the pixel columns each include the plurality of pixel circuits arranged along the first direction. At least one of the gate driving circuits is provided at each of two sides of the N/4-th one of the pixel-circuit columns along the first direction, and N/4 takes the integer part.

As shown in FIG. 12, the pixel-circuit columns are marked in the order from left to right, and the N/4-th pixel-circuit column 201 (1/4) and the 3N/4-th pixel-circuit column 201 (3/4) are marked, respectively. It may be understood that the 3N/4-th pixel-circuit column 201 (3/4) from left to right is the N/4th pixel-circuit column 201 from right to left.

The N/4-th one of the pixel-circuit columns 201 may include the N/4-th one of the pixel-circuit column 201 from left to right, and the N/4-th one of the pixel-circuit columns 201 from right to left.

In an example, along the direction from left to right, at least one of the gate driving circuits 10 is provided at each of two sides of the N/4-th one of the pixel-circuit columns 201 along the first direction X, and along the direction from right to left, at least one of the gate driving circuits 10 is provided at each of two sides of the N/4-th one of the pixel-circuit columns 201 along the first direction X.

For example, N=240, along the direction from left to right, at least one of the gate driving circuits is provided at each of two sides of the 60th pixel-circuit column along the first direction, and along the direction from left to right, at least one of the gate driving circuits is provided at each of two sides the 180th pixel-circuit column along the first direction. In other words, N=240, along the direction from right to left, at least one of the gate driving circuits is provided at each of two sides of the 60th pixel-circuit column along the first direction, and along the direction from right to left, at least one of the gate driving circuits is provided at each of two sides the 180th pixel-circuit column along the first direction.

In this embodiment, by improving the positional relationship among the gate driving circuits and the pixel-circuit columns, the gate driving circuits are no longer limited in the peripheral display area but are distributed at two sides of the N/4-th one of the pixel-circuit columns, so that even if the number of the gate driving circuits is relatively great, there is the sufficient display area to accommodate the gate driving circuits, thereby achieving the bezel-less-ness; in addition, compared to limiting the gate driving circuits in the peripheral display area, dispersing the gate driving circuits at two sides of the N/4-th one of the pixel-circuit columns can shorten the distance from at least a part of the gate driving circuits to the center of the display area, and can shorten the distance for the gate driving circuits to charge the pixel circuits in the center of the display area, thereby reducing the signal delay and the voltage drop, and improving the display uniformity.

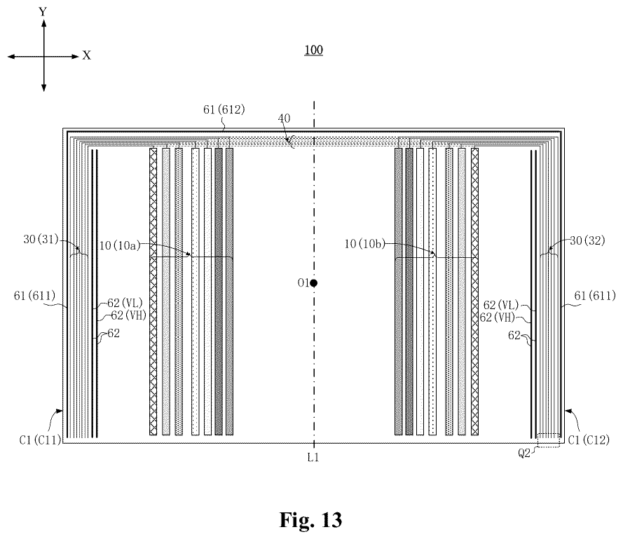

In some embodiments, as shown in FIG. 13, the display panel further includes the static electricity ring lines 61, and at least part of the static electricity ring lines 61 is located at a side of the trigger traces 30 away from the center O1 of the display panel. The center O1 is located on the midpoint of the first middle line L1 along the second direction Y.

In an example, the static electricity ring lines 61 each include the first protection segment 611 extending along the second direction Y and the second protection segment 612 extending along the first direction X. Along the first direction X, the first protection segments 611 are located at a side of the trigger traces 30 away from the first middle line L1. Along the second direction Y, the second protection segments 612 are located at a side of the trigger traces 30 away from the center O1. In an example, the second protection segments 612 are further located at a side of the trigger connection lines 40 away from the center O1.

The static electricity ring lines 61 are provided with the ground signal (GND signal) and can be used for preventing an effect of static electricity signals on the signal lines on the display panel. In this example, the trigger traces 30 and the trigger connection lines 40 are provided inside the static electricity ring lines 61, so that the static electricity ring lines 61 can prevent an effect of peripheral static electricity on the trigger traces 30 and the trigger connection lines 40.

In some embodiments, still referring to FIG. 13, the display panel further includes the fixed-voltage signal lines 62, and at least part of the fixed-voltage signal lines 62 is located at a side of the trigger traces 30 close to the center O1 of the display panel center.

For example, along the first direction X, the fixed-voltage signal lines 62 are provided at two sides of the first middle line L1 and each may include the first fixed-voltage signal line 62 (VH) and the second fixed-voltage signal line 62 (VL), the first fixed-voltage signal lines 62 (VH) are used for transmitting the high level, and the second fixed-voltage signal lines 62 (VL) are used for transmitting the low level. Along the first direction X, the first fixed-voltage signal lines 62 (VH) and the second fixed-voltage signal lines 62 (VL) are located at a side of the trigger traces 30 close to the first middle line L1.

In this example, since the fixed-voltage signal lines 62 transmit the fixed-voltage signal, the fixed-voltage signal lines 62 can block the interference of other signal lines in the trigger traces 30, thereby further ensuring the stability of the signals on the trigger traces 30.

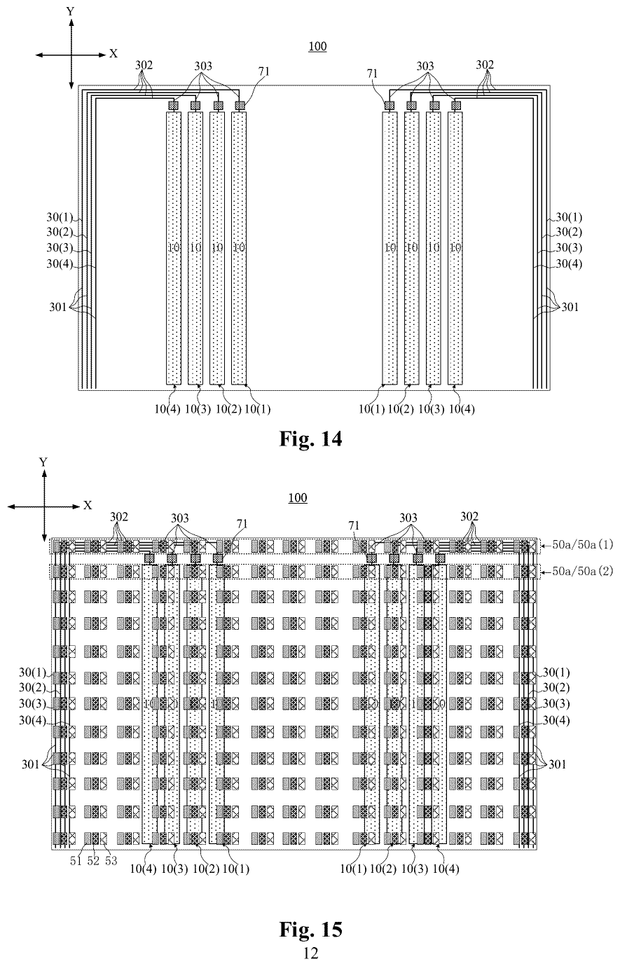

In some embodiments, as shown in FIG. 14, the gate driving circuits 10 each include the first end and the second end which are opposite to each other along the second direction Y, and the first ends of the gate driving circuits 10 are connected to the trigger traces 30. The display panel further includes the first static electricity protection circuits 71 electrically connected to the trigger traces 30, and the first static electricity protection circuits 71 are adjacent to the first ends of the gate driving circuits 10.

In an example, the first static electricity shield circuits 71 are used for discharging the static electricity on the trigger traces 30, thereby protecting the trigger traces 30 from the static electricity.

In an example, the trigger traces 30 each include the first segment 301, the second segment 302, and the third segment 303 which are connected to one another, the third segments 303 are connected to the first ends of the gate driving circuits 10, and the third segments 303 are electrically connected to the first static electricity protection circuits 71.

In this example, the principle of close proximity is used for providing the first static electricity protection circuits 71 and the gate driving circuits 10, for example, the first static electricity protection circuits 71 are distributed above the gate driving circuits 10 in FIG. 14, which breaks the conventional design in which static electricity protection circuits are designed at left and right corners of display panels, so that an effect of the surrounding static electricity environment on the inward extension of the trigger traces may be avoided.

In an example, along the direction from the second segments 302 to the first ends of the gate driving circuits 10, the third segments 303 are first connected to the first static electricity protection circuits 71, and then to the first ends of the gate driving circuits 10. In this example, the signals on the trigger traces 30 are first protected by the first static electricity protection circuits 71, and then transmitted to the gate driving circuits 10, so that an effect of external static electricity on the gate driving circuits can be avoided as much as possible.

In some embodiments, as shown in FIG. 14, the 1st one to the n-th one of the trigger traces 30 are electrically connected to the 1st one to the n-th one of the gate driving circuits 10 in a one-to-one correspondence, and the 1st one to the n-th one of the trigger traces 30 are electrically connected to the 1st one to the n-th one of the first static electricity protection circuits 71 in a one-to-one correspondence, and n≥2; the j-th one of the first static electricity protection circuits is adjacent to the first end of the j-th one of the gate driving circuits, and j is any one of 1 to N.

For example, in FIG. 14, four trigger traces 30, four gate driving circuits 10, and four first static electricity protection circuits are provided in each of the left half screen and the right half screen, and for the left half screen or the right half screen, the four first static electricity protection circuits 71 are provided above the four gate driving circuits 10 in a one-to-one correspondence. The respective trigger traces 30 are first connected to the first static electricity protection circuits 71, and then to the gate driving circuits 10. The signals on the trigger traces 30 are first protected by the first static electricity protection circuits 71, and then transmitted to the gate driving circuits 10.

In this embodiment, a plurality of first static electricity protection circuits 71, a plurality of trigger traces 30, and a plurality of gate driving circuits 10 are provided in a one-to-one correspondence, and the first static electricity protection circuits 71 are provided in close proximity to the gate driving circuits 10 corresponding to the first static electricity protection circuits 71, so that desired static electricity protection can be provided for each gate driving circuit 10.

In some embodiments, as shown in FIG. 14, the trigger traces 30 each include the first segment 301, the second segment 302, and the third segment 303 which are connected to one another, the second segment 302 is electrically connected between the first segment 301 and the third segment 303, the first segment 301 is electrically connected to a trigger signal terminal (not shown in the drawing) of the driving chip, the third segment 303 is electrically connected to the gate driving circuit 10, the first segment 301 and the third segment 303 extend along the second direction Y, and the second segment 302 extends along the first direction X. Along the second direction Y, the first static electricity protection circuit 71 is located between the second segment 302 and the gate driving circuit 10.

For the second segment 302 and the third segment 303 in the same trigger trace, the third segment 303 is located on a side of the second segment 302 close to the gate driving circuit 10.

In this embodiment, the first static electricity protection circuit 71 is provided between the second segment 302 and the gate driving circuit 10, further ensuring that the first static electricity protection circuits 71 can be provided in close proximity to the gate driving circuits 10 to ensure an static electricity protection effect.

In some embodiments, taking FIG. 15 as an example, the display area includes a plurality of light-emitting-device rows 50a, each of the light-emitting-device rows 50a includes a plurality of light-emitting devices arranged along the first direction X, each of the light-emitting devices may include the first light-emitting device 51, the second light-emitting device 52, and the third light-emitting device 53. The plurality of light-emitting-device rows are arranged along the second direction Y.

The orthographic projections of the first static electricity protection circuits 71 on the plane where the display panel is located are located between the orthographic projection of the 1st light-emitting-device row 50a (1) on the plane where the display panel is located and the orthographic projection of the 2nd light-emitting-device row 50a (2) on the plane where the display panel is located.

For example, the dimensions of the plurality of pixel circuits along the first direction and the second direction in the display panel may be compressed, and along the first direction X, there is the space between adjacent pixel circuits for placing the gate driving circuits; and along the first direction X, there is the space around the periphery of the display area for placing the trigger traces. Along the second direction Y, there is the space around the periphery of the display area for placing the trigger traces and the first static electricity protection circuits.

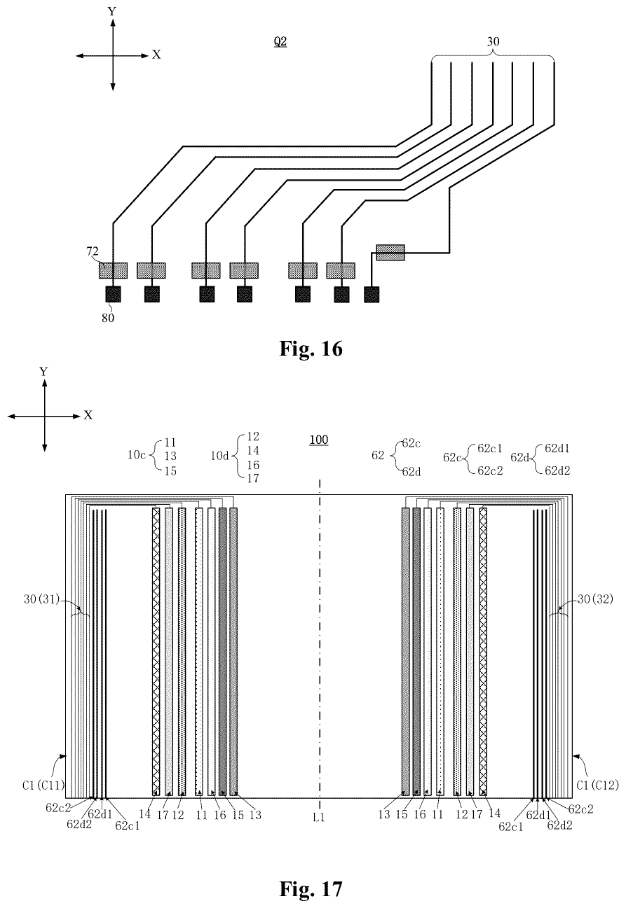

In some embodiments, referring to FIG. 13 and FIG. 16, the first ends of the trigger traces 30 are electrically connected to the trigger signal terminal 80; along second direction Y, the trigger signal terminals 80 are located at a side of the gate driving circuits 10, and along the first direction X, the trigger signal terminal 80 are located between the gate driving circuits 10 and the trigger traces 30. The trigger signal terminals 80 are electrically connected to the driving chip and used for transmitting the trigger signal provided by the driving chip to the trigger traces 30.

That is, along the first direction X, the trigger signal terminals 80 are provided close to the first edges C1 of the display panel, which means the trigger signal terminals 80 are provided at the lower left corner and/or the lower right corner of the display panel, so as to provide the trigger signals for the trigger traces at the left side and the right side in close proximity.

In some embodiments, referring to FIG. 13 and FIG. 16, the display panel further includes the second static electricity protection circuits 72 which are electrically connected to the trigger traces 30 and adjacent to the trigger signal terminals 80. That is, the second static electricity protection circuits 72 are provided in close proximity to the trigger signal terminals 80 and also provided at the lower left corner and/or the lower right corner of the display panel.

The second static electricity protection circuits 72 are electrically connected between the trigger signal terminals 80 and the trigger traces 30, and the signals output by the trigger signal terminals 80 are first protected by the second static electricity protection circuits 72, and then transmitted to the trigger traces 30, thereby ensuring the static electricity protection effect for the signals passing through the trigger traces 30.

In some embodiments, as shown in any one of FIG. 9 to FIG. 11, the pixel circuits 20 each include the amplitude modulation sub-circuit 21 and the pulse width modulation sub-circuit 22. As shown in FIG. 17, the gate driving circuits include the first type gate driving circuits 10c and the second type gate driving circuits 10d, the first type gate driving circuits 10c are configured to drive the amplitude modulation sub-circuits 21, and the second type gate driving circuits 10d are configured to drive the pulse width modulation sub-circuits 22. For example, the gate signal PAM_S2 output by the first gate driving circuits 11 is used for controlling the writing of the first data signal PAM_data into the amplitude modulation sub-circuits 21, the gate signal PWM_S2 output by the second gate driving circuits 12 is used for controlling the writing of the second data signal PWM_data into the pulse width modulation sub-circuits 22, the gate signal PAM_S1 output by the third gate driving circuits 13 is used for controlling the writing of the reset signal PAM_REF1 into the amplitude modulation sub-circuits 21, and the gate signal PWM_S1 output by the fourth gate driving circuits 14 is used for controlling the writing of the reset signal PWM_REF1 into the pulse width modulation sub-circuits 22. In addition, the fifth gate driving circuits 15 are configured to output the first light-emitting control signal PAM_EM, the sixth gate driving circuits 16 are configured to output the second light-emitting control signal PWM_EM, the seventh gate driving circuits 17 are configured to output the frequency sweep signal SWEEP, the fifth gate driving circuits 15 are electrically connected to the amplitude modulation sub-circuits 21, and the sixth gate driving circuits 16 and the seventh gate driving circuits 17 are electrically connected to the pulse width modulation sub-circuits 22. The first type gate driving circuits 10c include the first gate driving circuit 11, the third gate driving circuit 13, and the fifth gate driving circuit 15. The second type gate driving circuits 10d include the second gate driving circuit 12, the fourth gate driving circuit 14, the sixth gate driving circuit 16, and the seventh gate driving circuit 17.

The fixed-voltage signal lines 62 of the display panel include the first type fixed-voltage signal lines 62c and the second type fixed-voltage signal lines 62d, the first type fixed-voltage signal lines 62c are electrically connected to the first type gate driving circuits 10c, and the second type fixed-voltage signal lines 62d are electrically connected to the second type gate driving circuits 10d.

In an example, the first type fixed-voltage signal lines 62c include the first sub-fixed-voltage signal lines 62c1 and the second sub-fixed-voltage signal lines 62c2, the first sub-fixed-voltage signal lines 62c1 are used for transmitting the first high-level voltage VGH1, and the second sub-fixed-voltage signal lines 62c2 are used for transmitting the first low-level voltage VGL1.

The second type fixed-voltage signal lines 62d include the third sub-fixed-voltage signal lines 62d1 and the fourth sub-fixed-voltage signal lines 62d2, the third sub-fixed-voltage signal lines 62d1 are used for transmitting the second high-level voltage VGH2, and the fourth sub-fixed-voltage signal lines 62d2 are used for transmitting the second low-level voltage VGL2.

In an example, the first high-level voltage VGH1 is not equal to the second high-level voltage VGH2, and/or, the first low-level voltage VGL1 is not equal to the second low-level voltage VGL2. For example, the first high-level voltage VGH1 is 3V, and the first low-level voltage VGL1 is −12V. As another example, the second high-level voltage VGH2 is 8V, and the second low-level voltage VGL2 is −7V.

In this embodiment, the two types of fixed-voltage signal lines are designed to provide power for the two types of gate driving circuits, respectively, and the two types of gate driving circuits are configured to drive the amplitude modulation sub-circuits and the pulse width modulation sub-circuits, respectively, so that it is convenient to flexibly adjust the magnitude of the fixed-voltage signals on the two types of fixed-voltage signal lines based on the respective requirements for the amplitude modulation sub-circuits and the pulse width modulation sub-circuits, so as to better meet the requirements for the source-drain cross-voltages of transistors in the amplitude modulation sub-circuits and the pulse width modulation sub-circuits, thereby reducing the threshold voltage drift and leakage of the transistors.

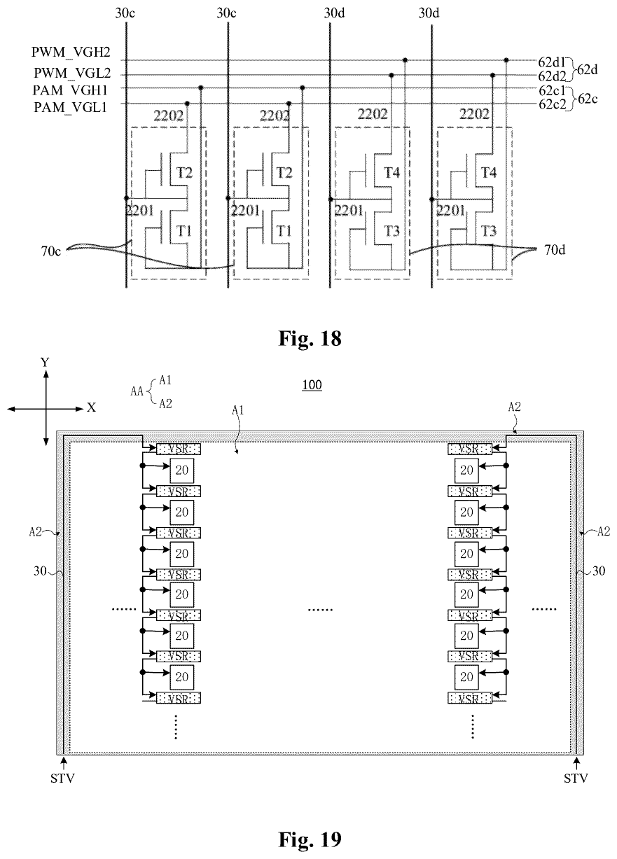

In some embodiments, under a condition that the gate driving circuits include the first type gate driving circuits and the second type gate driving circuits, as shown in FIG. 18, the static electricity protection circuits of the display panel may be divided into the first type static electricity protection circuits 70c and the second type static electricity protection circuits 70d, and the trigger traces may be divided into the first type trigger traces 30c connected to the first type gate driving circuits and the second type trigger traces 30d connected to the second type gate driving circuits. The first type static electricity protection circuits 70c are electrically connected to the first type trigger traces 30c, and the second type static electricity protection circuits 70d are electrically connected to the second type trigger traces 30d. In addition, the first type static electricity protection circuits 70c are electrically connected to the first type fixed-voltage signal lines 62c, and the second type static electricity protection circuits 70d are electrically connected to the second type fixed-voltage signal lines 62d.

In an example, as shown in FIG. 18, the first type static electricity protection circuits 70c and the second type static electricity protection circuits 70d each include the first end 2201 and the second end 2202. The first ends 2201 of the first type static electricity protection circuits 70c are electrically connected to the first type trigger traces 30c, and the second ends 2202 of the first type static electricity protection circuits 70c are electrically connected to the first type fixed-voltage signal lines 62c. The first ends 2201 of the second type static electricity protection circuits 70d are electrically connected to the second type trigger traces 30d, and the second ends 2202 of the second type static electricity protection circuits 70d are electrically connected to the second type fixed-voltage signal lines 62d.

As an example, the first type static electricity protection circuits 70c each include the first transistor T1 and the second transistor T2. The control ends and the first ends of the first transistors T1 are electrically connected to the first sub-fixed-voltage signal line 62c1, and the second ends of the first transistors T1 are electrically connected to the control ends and the first ends of the second transistors T2, respectively, and are electrically connected to the first type trigger traces 30c as the first ends 2201; and the second ends of the second transistors T2 are electrically connected to the second sub-fixed-voltage signal lines 62c2.

The second type static electricity protection circuits 70d each include the third transistor T3 and the fourth transistor T4. The control ends and the first ends of the third transistors T3 are electrically connected to the third sub-fixed-voltage signal line 62d1, and the second ends of the third transistor T3 are electrically connected to the control ends and the first ends of the fourth transistors T4, respectively, and are electrically connected to the second type trigger traces 30d as the first ends 2201; and the second ends of the fourth transistors T4 are electrically connected to the fourth sub-fixed-voltage signal lines 62d2.

As shown in FIG. 18 for illustration, the first transistors T1, the second transistors T2, the third transistors T3, and the fourth transistors T4 may be the N-type channel transistors or the P-type channel transistors, which is not limited herein.

An example is given below in which the first transistors T1, the second transistors T2, the third transistors T3, and the fourth transistors T4 are the N-type channel transistors to describe the operation principle of the static electricity protection circuits.

For the first type static electricity protection circuits 70c, when the first type trigger traces 30c generate the high-voltage static electricity, the high-voltage static electricity voltage signals of the first type trigger traces 30c are input to the first ends 2201 of the first type static electricity protection circuits 70c, and under this condition, the first transistors T1 are turned on, and then the high-voltage static electricity signals release the high-voltage static electricity signals through the first transistors T1 to the first sub-fixed-voltage signal line 62c1 which transmits the high-level voltage VGH1.

When the first type trigger traces 30c generate the low-voltage static electricity, the low-voltage static electricity voltage signals of the first type trigger traces 30c are input to the first ends 2201 of the first type static electricity protection circuits 70c, and under this condition, the second transistors T2 are turned on, and the low-voltage static electricity signals release the low-voltage static electricity signals through the second transistors T2 to the second sub-fixed-voltage signal line 62c2 which transmits the low-level voltage VGL1, achieving the static electricity release.

The operation principle of the second type static electricity protection circuits 70d is the same as that of the first type static electricity protection circuits 70c, which is not repeated herein.

In a word, the first type static electricity protection circuits 70c and the second type static electricity protection circuits 70d can achieve the effective release of the high-voltage static electricity and the low-voltage static electricity which are generated in the display panel, which can avoid the damage of the static electricity to the internal structures of the panel, thereby ensuring the quality and performance of the display panel.

Of course, the structures of the static electricity protection circuits shown in FIG. 18 are only an example, which is not intended to limit the present application.

It may be understood that the first static electricity protection circuit described in the above embodiment may be divided into the first type static electricity protection circuits and the second type static electricity protection circuits, and the second static electricity protection circuit may also be divided into the first type static electricity protection circuits and the second type static electricity protection circuits, which is not repeated herein.

In an example, as shown in FIG. 19, the gate driving circuits each include a plurality of shift registers VSR in a cascaded connection, and the plurality of shift registers VSR are arranged along the second direction Y. In an example, the dimensions of the pixel circuits 20 along the second direction Y are compressed, so that there is space between the pixel circuits 20 along the second direction Y for providing the shift registers VSR. In an example, the orthographic projections of the shift registers VSR on the plane where the display panel is located do not overlap the orthographic projections of the pixel circuits 20 on the plane where the display panel is located.

It should be noted that the number of the signal lines and the number of the gate driving circuits shown in the respective drawings of the present application are only examples and are not intended to limit the present application.

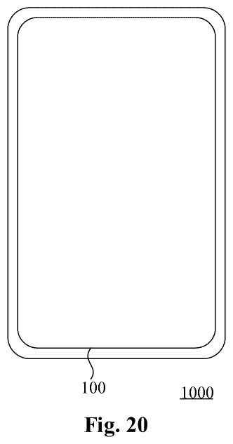

The present application further provides a display apparatus including the display panel according to the present application. Reference is made to FIG. 20 which is a schematic structural view of the display apparatus according to the embodiments of the present application. The display apparatus 1000 according to FIG. 20 includes the display panel 100 according to any one of the above embodiments of the present application. In the embodiment of FIG. 20, only the mobile phone is given as an example to illustrate the display apparatus 1000, and it may be understood that, the display apparatus according to the embodiments of the present application may be other display apparatus with the display function, such as, a wearable product, a computer, a television, and a vehicle-mounted display apparatus, which are not are not particularly limited by the embodiments of the present application. The display apparatus according to the embodiments of the present application has the beneficial effects of the display panel according to the embodiments of the present application, reference is made to the specific description of the display panel in the above embodiments for details, which are not repeated herein.

The above embodiments of the present application do not exhaustively describe all the details and do not limit the present application to only the specific embodiments described. Obviously, many modifications and variations can be made based on the above description. These embodiments are selected and specifically described in the description to better explain the principles and practical applications of the present application, so that those skilled in the art can make good use of the present application and make modifications based on the present application. The present application is limited only by the claims, along with their full scope and equivalents.

What is claimed is:

1. A display panel comprising a display area, wherein
the display area comprises a first area and a second area at least partially surrounding the first area,
gate driving circuits and pixel circuits electrically connected to the gate driving circuits are provided in the first area,
trigger traces are provided in the second area, no pixel circuits are provided in the second area, and the trigger traces are electrically connected to the gate driving circuits.

2. The display panel according to claim 1, wherein
the 1st one to the n-th one of the trigger traces are electrically connected to the 1st one to the n-th one of the gate driving circuits in a one-to-one correspondence, and n≥2; and
the 1st one to the n-th one of the trigger traces do not intersect with each other.

3. The display panel according to claim 2, wherein
one of the trigger traces comprises a first segment, a second segment, and a third segment which are connected to one another, the second segment is electrically connected between the first segment and the third segment, the first segment is electrically connected to a trigger signal terminal, the third segment is electrically connected to the gate driving circuit, the second segment extends along a first direction, the first segment and the third segment extend along a second direction, and the first direction intersects with the second direction; and
along the first direction, arrangement order of the first segments of the 1st one to the n-th one of the trigger traces is opposite to arrangement order of the 1st one to the n-th one of the gate driving circuits; and arrangement order of the third segments of the 1st one to the n-th one of the trigger traces is the same as arrangement order of the 1st one to the n-th one of the gate driving circuits.

4. The display panel according to claim 1, wherein
the trigger traces comprise first trigger traces and second trigger traces, and along a first direction, the first trigger traces and the second trigger traces are located at two sides of a center of the display area, respectively; and
trigger connection lines are provided in the second area and are electrically connected between the first trigger traces and the second trigger traces.

5. The display panel according to claim 4, wherein
at least one of the trigger connection lines comprises a first connection segment and a second connection segment which are connected to each other, the first connection segment at least partially overlaps the trigger traces, and the second connection segment does not overlap the trigger traces; and
a line width of the first connection segment is less than a line width of the second connection segment.

6. The display panel according to claim 5, wherein
the first connection segment is located in a first metal layer of the display panel, the second connection segment is located in a second metal layer of the display panel, and sheet resistance of the second metal layer is less than sheet resistance of the first metal layer.

7. The display panel according to claim 1, wherein the display area comprises a plurality of light-emitting-device columns, and along a thickness direction of the display panel, the trigger traces overlap the 1st one of the light-emitting-device columns or the last one of the light-emitting-device columns; or
the display area comprises a plurality of light-emitting-device rows, and along the thickness direction of the display panel, the trigger traces at least partially overlap the 1st one of the light-emitting-device rows.

8. The display panel according to claim 1, wherein
the display area comprises a first middle line, a width of the display panel along the first direction is D, the first middle line extends along the second direction, a distance between the first middle line and one of first edges of the display panel along the first direction is d1, d1=D/2,
at least one of the gate driving circuits is provided at each of two sides of the first middle line along the second direction, and the first direction intersects with the second direction.

9. The display panel according to claim 8, wherein
n of the gate driving circuits are provided at each of two sides of the first middle line along the first direction, and the gate driving circuits at two sides of the first middle line are symmetrically provided; or
a distance between one of second middle lines of the display area and the first middle line of the display area along the first direction is d2, d2=D/4, and at least one of the gate driving circuits is provided at each of two sides of the second middle line along the first direction.

10. The display panel according to claim 8, wherein the display panel comprises N pixel-circuit columns arranged along the first direction, and one of the pixel-circuit columns comprises a plurality of the pixel circuits arranged along the second direction; and
at least one of the gate driving circuits is provided at each of two sides of the N/4-th one of the pixel-circuit columns along the first direction, and N/4 takes an integer part.

11. The display panel according to claim 1, wherein the display panel further comprises static electricity ring lines, and at least part of the static electricity ring lines is located at a side of the trigger traces away from a center of the display panel; or
the display panel further comprises fixed-voltage signal lines, and at least part of the fixed-voltage signal lines is located at a side of the trigger traces close to a center of the display panel.

12. The display panel according to claim 1, wherein one of the gate driving circuits comprises a first end and a second end which are opposite to each other along a first direction, and the first ends of the gate driving circuits are connected to the trigger traces; and
the display panel further comprises first static electricity protection circuits electrically connected to the trigger traces, and the first static electricity protection circuits are adjacent to the first ends of the gate driving circuits.

13. The display panel according to claim 12, wherein the display area comprises a plurality of light-emitting-device rows, and orthographic projections of the first static electricity protection circuits on a plane where the display panel is located are located between an orthographic projection of the first one of the light-emitting-device rows on the plane where the display panel is located and an orthographic projection of the second one of the light-emitting-device rows on the plane where the display panel is located.

14. The display panel according to claim 12, wherein the 1st one to the n-th one of the trigger traces are electrically connected to the 1st one to the n-th one of the gate driving circuits in a one-to-one correspondence, and the 1st one to the n-th one of trigger traces are electrically connected to the1st one to the n-th one of the first static electricity protection circuits in a one-to-one correspondence, and n≥2; and
the j-th one of the first static electricity protection circuits is adjacent to the first end of the j-th one of the gate driving circuits, and j is any one of 1 to n.

15. The display panel according to claim 14, wherein
one of the trigger traces comprises a first segment, a second segment, and a third segment which are connected to one another, the second segment is electrically connected between the first segment and the third segment, the first segment is electrically connected to a trigger signal terminal, the third segment is electrically connected to the gate driving circuit, the first segment and the third segment extend along a second direction, the second segment extends along a first direction, and the first direction intersects with the second direction; and
along the second direction, the first static electricity protection circuits are located between the second segments and the gate driving circuits.

16. The display panel according to claim 1, wherein first ends of the trigger traces are electrically connected to trigger signal terminals,
along a second direction, the trigger signal terminals are located at a side of the gate driving circuits,
and along a first direction, the trigger signal terminals are located between the gate driving circuits and the trigger traces.

17. The display panel according to claim 16, wherein the display panel further comprises second static electricity protection circuits which are electrically connected to the trigger traces and adjacent to the trigger signal terminals.

18. The display panel according to claim 1, wherein one of the pixel circuits comprises an amplitude modulation sub-circuit and a pulse width modulation sub-circuit, the gate driving circuits comprise first-type gate driving circuits and second-type gate driving circuits, the first-type gate driving circuits are configured to drive the amplitude modulation sub-circuits, and the second-type gate driving circuits are configured to drive the pulse width modulation sub-circuits; and
fixed-voltage signal lines of the display panel comprise first-type fixed-voltage signal lines and second-type fixed-voltage signal lines, the first-type fixed-voltage signal lines are electrically connected to the first-type gate driving circuits, and the second-type fixed-voltage signal lines are electrically connected to the second-type gate driving circuits.

19. The display panel according to claim 18, wherein the static electricity protection circuits of the display panel comprise first-type static electricity protection circuits and second-type static electricity protection circuits, the first-type static electricity protection circuits are electrically connected to the trigger traces connected to the first-type gate driving circuits, and the second-type static electricity protection circuits are electrically connected to trigger traces connected to the second-type gate driving circuits; and
the first-type static electricity protection circuits are electrically connected to the first-type static electricity fixed-voltage signal lines, and the second-type static electricity protection circuits are electrically connected to the second-type fixed-voltage signal lines.

20. A display apparatus comprising a display panel, the display panel comprising a display area, wherein the display area comprises a first area and a second area at least partially surrounding the first area,
gate driving circuits and pixel circuits electrically connected to the gate driving circuits are provided in the first area,
trigger traces are provided in the second area, no pixel circuits are provided in the second area, and the trigger traces are electrically connected to the gate driving circuits.
